(19) United States
(12) Patent Application Publication
(10) Pub. No.: US 2019/0334146 A1
(43) Pub. Date: Oct. 31, 2019

(54) PROTECTION DEVICE FOR BATTERY, BATTERY, BATTERY PACK, AND VEHICLE

(71) Applicant: BYD COMPANY LIMITED, Shenzhen (CN)

(72) Inventors: Qing LAI, Shenzhen (CN); Zhiwei TONG, Shenzhen (CN); Yan ZHU, Shenzhen (CN); Jianhua ZHU, Shenzhen (CN)

(73) Assignee: BYD COMPANY LIMITED, Shenzhen (CN)

(21) Appl. No.: 16/474,868

(22) PCT Filed: Jun. 8, 2017
(86) PCT No.: PCT/CN2017/087567

§ 371 Date: Jun. 28, 2019

(30) Foreign Application Priority Data
Dec. 30, 2016 (CN) 201611269807.0

(51) Int. Cl. H01M 2/12; A62C 3/16; A62C 31/00

(52) U.S. Cl. CPC H01M 2/1241; B60R 16/04; A62C 31/00; A62C 3/16

(57) ABSTRACT

A protection device includes a casing assembly, a sealing film, and a temperature-sensitive actuating piece. A receiving chamber for receiving an inert gas is defined in the casing assembly. One end of the receiving chamber is provided with an opening. The sealing film is disposed at the opening to seal the receiving chamber. The actuating piece is disposed in the receiving chamber, and the actuating piece is provided with a piercing protrusion. When the actuating piece is deformed, the piercing protrusion pierces the sealing film.

### CROSS-REFERENCE TO RELATED APPLICATIONS

This application is the U.S. national phase entry of PCT Application No. PCT/CN2017/087567, filed Jun. 8, 2017, which claims priority to and benefits of Chinese Patent Application Serial No. 201611269807.0, filed with the State Intellectual Property Office of P. R. China on Dec. 30, 2016. The entire contents of the above-referenced applications are incorporated herein by reference.

### FIELD

The present disclosure relates to the technical fields of batteries, and in particular, to a protection device for a battery, a battery, a battery pack, and a vehicle.

### BACKGROUND

In the related art, a PACK system includes a battery module. The battery module is difficult to design with an automatic fire extinguishing system. Most of fire-fighting systems are mounted on the PACK system, or there is no fire-fighting system directly. Since the PACK system has different sizes, it is difficult to consider the arrangement of the fire-fighting systems mounted on the PACK system at each angle, so there is a problem that the response time of the fire-fighting system lags and extinguishing is not perfect.

### SUMMARY

An objective of the present disclosure is to at least resolve one of the technical problems in the related art to some extent. In view of this, the present disclosure provides a protection device for a battery. The protection device has the advantages of simple structure and reaction sensitivity.

The present disclosure also provides a battery. The battery has the protection device for a battery as described above.

The present disclosure also provides a battery pack. The battery pack has the battery as described above.

The present disclosure also provides a vehicle. The vehicle has the battery pack as described above.

The protection device for a battery according to an embodiment of the present disclosure includes: a casing assembly, a receiving chamber for receiving an inert gas being defined in the casing assembly, one end of the receiving chamber being provided with an opening; a sealing film, the sealing film being disposed at the opening to seal the receiving chamber; and a temperature-sensitive and deformable actuating piece, the actuating piece being disposed in the receiving chamber and provided with a piercing protrusion, wherein when the actuating piece is deformed in response to a temperature change of the battery, the piercing protrusion is driven to pierce the sealing film.

In the protection device for a battery according to an embodiment of the present disclosure, by utilizing the temperature-sensitive characteristic of the actuating piece, when the actuating piece is deformed, the piercing protrusion can be driven to pierce the sealing film, so as to release the inert gas in the receiving chamber. After the inert gas in the receiving chamber is released, the state of the protection device can be monitored by detecting the inert gas, so that the working state of the battery can be monitored. Therefore, it is convenient to monitor the state of the battery, and the abnormal heat generation condition of the battery can be found in time, thereby improving the working safety and stability of the battery.

In some embodiments, the protection device further includes a pressing ring. The pressing ring is disposed on the actuating piece and is in close contact with the actuating piece. The piercing protrusion passes through the pressing ring and protrudes toward the sealing film.

In some embodiments, a free end of the piercing protrusion is formed as a tip end.

In some embodiments, the sealing film is a plastic film.

In some embodiments, the actuating piece is a memory alloy piece.

In some embodiments, the casing assembly includes: an outer casing, defining the receiving chamber, the opening of the receiving chamber being located at one end of the outer casing; and an inner casing, which is a metal member disposed on an inner peripheral wall of the outer casing and in close contact with the inner peripheral wall of the outer casing, an end of the inner casing adjacent to the opening being spaced apart from the opening, the actuating piece abutting against the end of the inner casing.

In some embodiments, the outer casing is a plastic part.

The battery according to an embodiment of the present disclosure includes: a battery body; a spraying assembly, the spraying assembly corresponding to the battery body and adapted to spray a fire extinguishing agent to the battery body; the protection device for a battery as described above; and a fire-fighting sensing assembly, adapted to sense that an inert gas in the protection device is released, the fire-fighting sensing assembly being in communication connection with the spraying assembly, wherein when the inert gas in the protection device is released, the spraying assembly sprays the fire extinguishing agent to the battery body.

In the battery according to an embodiment of the present disclosure, by utilizing the temperature-sensitive characteristic of the actuating piece, when the actuating piece is deformed, the piercing protrusion can be used to pierce the sealing film. After the inert gas in the receiving chamber is released, the state of the protection device can be monitored by detecting the inert gas, so that the working state of the battery can be monitored. Therefore, it is convenient to monitor the state of the battery, and the abnormal heat generation condition of the battery can be found in time, thereby improving the working safety and stability of the battery.

The battery pack according to an embodiment of the present disclosure includes: a box; a plurality of batteries as described above, the plurality of batteries being disposed in the box; and a fire-fighting pipeline, disposed along the periphery of the battery pack, the fire-fighting pipeline having a plurality of pipeline branches, each battery corresponding to at least one pipeline branch, a free end of each pipeline branch being connected to a spraying assembly of the battery.

In the battery pack according to an embodiment of the present disclosure, by utilizing the temperature-sensitive characteristic of the actuating piece, when the actuating piece is deformed, the piercing protrusion can be driven to pierce the sealing film, so as to release the inert gas in the receiving chamber. After the inert gas in the receiving chamber is released, the state of the protection device can be monitored by detecting the inert gas, so that the working state of the battery can be monitored. Therefore, it is convenient to monitor the state of the battery, and the abnormal heat generation condition of the battery can be found in time, thereby improving the working safety and stability of the battery pack.

The vehicle according to an embodiment of the present disclosure includes the battery pack as described above.

In the vehicle according to an embodiment of the present disclosure, by utilizing the temperature-sensitive characteristic of the actuating piece, when the actuating piece is deformed, the piercing protrusion can be driven to pierce the sealing film, so as to release the inert gas in the receiving chamber. After the inert gas in the receiving chamber is released, the state of the protection device can be monitored by detecting the inert gas, so that the working state of the battery can be monitored. Therefore, it is convenient to monitor the state of the battery, and the abnormal heat generation condition of the battery can be found in time, thereby improving the working safety and stability of the battery pack and the vehicle.

### BRIEF DESCRIPTION OF THE DRAWINGS

FIG. 1 is a schematic cross-sectional view of a protection device for a battery in which an actuating piece is not deformed according to an embodiment of the present disclosure;

FIG. 2 is a schematic cross-sectional view of a protection device for a battery in which an actuating piece is deformed and pierces a sealing film according to an embodiment of the present disclosure;

FIG. 3 is a schematic structural view of a battery pack in which a box of the battery pack is not shown according to an embodiment of the present disclosure;

FIG. 4 is a partial enlarged view of Part Ain FIG. 3;

FIG. 5 is a schematic structural view of a battery pack according to an embodiment of the present disclosure; and

FIG. 6 is another schematic structural view of a battery pack according to an embodiment of the present disclosure.

Reference numerals of the accompanying drawing: Protection device 100.

Casing assembly 110, outer casing 111, receiving chamber 112, opening 113, and inner casing 114.

Sealing film 120.

Actuating piece 130, piercing protrusion 131, and tip end 132.

Pressing ring 140.

Battery 200.

Battery body 210.

Spraying assembly 220.

Battery pack 300, fire-fighting pipeline 310, fan 320, and cover plate 330.

### DETAILED DESCRIPTION

The following describes embodiments of the present invention in detail. Examples of the embodiments are shown in the accompanying drawings. The embodiments described below with reference to the accompanying drawings are exemplary, aim to explain the disclosure, but cannot be understood as a limitation on the disclosure.

In the description of the present disclosure, it should be understood that, orientations or position relationships indicated by terms such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “axial”, “radial”, and “circumferential” are orientations or position relationship shown based on the accompanying drawings, and are merely used for describing the present disclosure and simplifying the description, rather than indicating or implying that the apparatus or element should have a particular orientation or be constructed and operated in a particular orientation, and therefore, should not be construed as a limitation on the present disclosure.

In addition, terms “first” and “second” are used only for description purposes, and shall not be understood as indicating or suggesting relative importance or implicitly indicating a quantity of indicated technical features. Therefore, features defined by “first” and “second” may explicitly or implicitly include at least one feature. In the description of the present disclosure, unless otherwise specifically limited, “multiple” means at least two, for example, two or three.

In the present disclosure, unless otherwise clearly specified and limited, terms “mount”, “connected”, “connect”, and “fix” should be understood in a generalized manner, for example, may be understood as fixed connection, detachable connection, or integration; or may be understood as mechanical connection, electrical connection, or mutual communication; or may be understood as direct connection, or indirect connection by means of a medium, or internal communication of two elements or a mutual relationship between two elements, unless otherwise clearly specified. A person of ordinary skill in the art may understand specific meanings of the foregoing terms in this disclosure according to a specific situation.

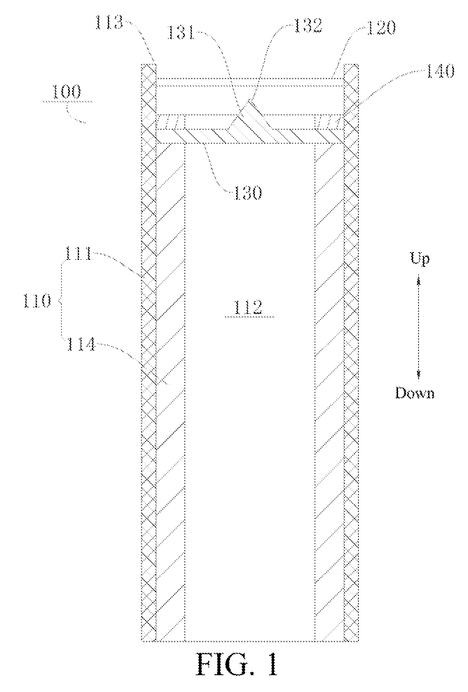

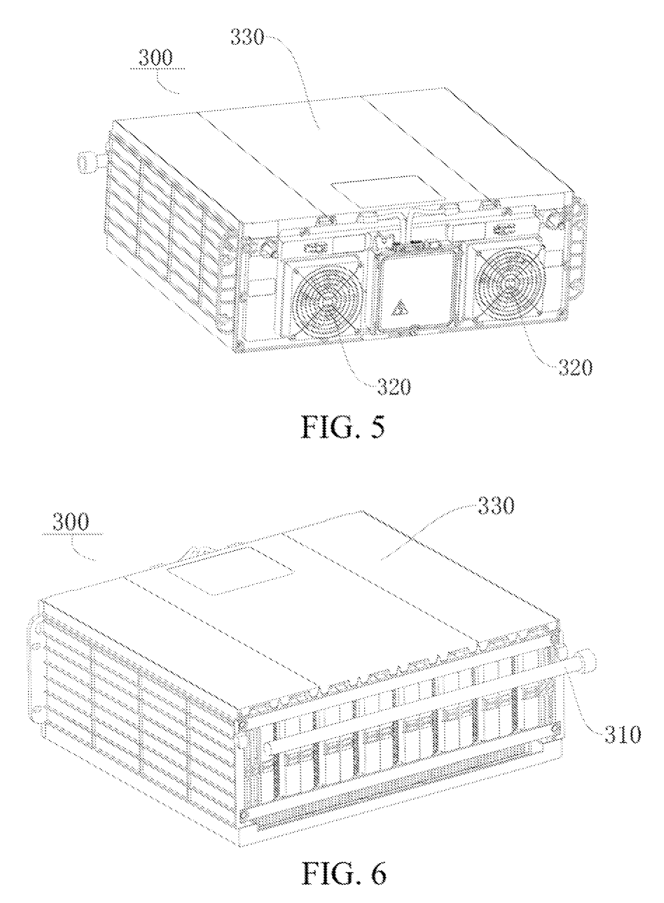

A protection device 100 for a battery 200, a battery 200, a battery pack 300 and a vehicle according to an embodiment of the present disclosure will be described in detail below with reference to FIGS. 1-6.

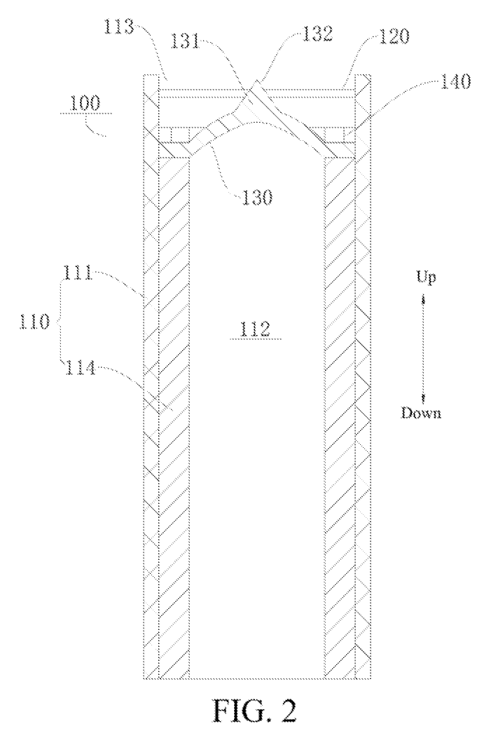

As shown in FIGS. 1-2, the protection device 100 for the battery 200 according to an embodiment of the present disclosure includes: a casing assembly 110, a sealing film 120 and a temperature-sensitive actuating piece 130.

Specifically, a receiving chamber 112 for receiving an inert gas (e.g., nitrogen or helium) is defined in the casing assembly 110, and one end of the receiving chamber 112 has an opening 113. For example, as shown in FIG. 1, an upper end of the casing assembly 110 is open to form an opening 113. The sealing film 120 is disposed at the opening 113 to seal the receiving chamber 112. It should be noted that the receiving chamber 112 is filled with an inert gas, when the inert gas is released, the presence of the inert gas may be sensed by a detection device for detecting the inert gas within a certain space, or the release of the inert gas may be sensed by detecting the pressure within a space where the protection device 100 is located. For example, when the protection device 100 and the battery 200 are assembled together into a mounting space of the battery 200, and when the inert gas in the protection device 100 is released, the pressure in the mounting space is increased, so that the state of the protection device 100 can be monitored by detecting the pressure in the mounting space.

As shown in FIG. 1 and FIG. 2, the actuating piece 130 is disposed in the receiving chamber 112, the actuating piece 130 is provided with a piercing protrusion 131, and when the actuating piece 130 is deformed, the piercing protrusion 131 is driven to pierce the sealing film 120. In some embodiments of the present disclosure, the temperature-sensitive and deformable actuating piece 130 may produce a certain amount of deformation when the temperature of the space where the protection device 100 is located changes. When the amount of deformation of the actuating piece 130 is sufficiently large, the actuating piece 130 may drive the piercing protrusion 131 to pierce the sealing film 120 to release the inert gas.

For convenience of understanding, the protection device 100 of the embodiment of the present disclosure will be described by taking the piercing protrusion 131 on the actuating piece 130 piercing the sealing film 120, as the temperature rises to a predetermined degree Celsius, as an example. It will be appreciated that the following description is only illustrative and not specifically restrictive to the present disclosure.

In some embodiments, the protection device 100 and a device for detecting pressure around the battery 200 (e.g., a fire-fighting sensing assembly) may be disposed on the battery 200 to detect the temperature of the battery 200. The battery 200 is liable to be short-circuited due to problems such as aging during use. When the battery 200 is short-circuited, the temperature of the battery 200 will rise, and heat on the battery 200 is transferred to the protection device 100. When the actuating piece 130 senses a higher temperature, it will be deformed. When the temperature rises to a certain extent, the actuating piece 130 generates a large amount of deformation, thereby driving the piercing protrusion 131 on the actuating piece 130 to pierce the sealing film 120. In this case, the inert gas is released, the pressure around the battery 200 changes, and the device for detecting the pressure around the battery 200 will give an alarm and notify a user of the state of the battery 200.

In the protection device 100 for the battery 200 according to an embodiment of the present disclosure, by utilizing the temperature-sensitive characteristic of the actuating piece 130, when the actuating piece 130 is deformed by heat, the piercing protrusion 131 can be driven to pierce the sealing film 120, so as to release the inert gas in the receiving chamber 112. After the inert gas in the receiving chamber 112 is released, the state of the protection device 100 can be monitored by detecting the inert gas, so that the working state of the battery 200 can be monitored. Therefore, it is convenient to monitor the state of the battery 200, and the abnormal heat generation condition of the battery 200 can be found in time, thereby improving the working safety and stability of the battery 200.

According to one embodiment of the present disclosure, as shown in FIG. 1 and FIG. 2, the protection device 100 for the battery 200 further includes a pressing ring 140. The pressing ring 140 is disposed on the actuating piece 130 and is in close contact with the actuating piece 130. The piercing protrusion 131 passes through the pressing ring 140 and protrudes toward the sealing film 120. The pressing ring 140 may fix the actuating piece 130 at the opening 113 of the casing assembly 110, so that the actuating piece 130 can be prevented from accidentally falling off or accidentally piercing the sealing film 120, thereby improving the reliability and sensitivity of the protection device 100.

Further, in order to enable the piercing protrusion 131 to pierce the sealing film 120 smoothly, as shown in FIG. 1 and FIG. 2, a free end of the piercing protrusion 131 may be formed as a tip end 132. In one embodiment of the present disclosure, the sealing film 120 may be a plastic film. On the one hand, it is convenient for the piercing protrusion 131 to pierce the sealing film 120. On the other hand, plastic is a common material with low cost, and the production cost of the protection device 100 can be saved. In another embodiment of the present disclosure, the actuating piece 130 may be a memory alloy piece. The memory alloy piece is highly sensitive to temperature. When the memory alloy piece encounters an appropriate temperature change, a sufficient amount of deformation can be generated, and the piercing protrusion 131 can be driven to pierce the sealing film 120, thereby not only improving the sensitivity of the protection device 100, but also saving the production cost of the protection device 100.

As shown in FIG. 1 and FIG. 2, according to one embodiment of the present disclosure, the casing assembly 110 includes: an outer casing 111 and an inner casing 114. The outer casing 111 defines a receiving chamber 112, and the opening 113 is located at one end of the outer casing 111. The inner casing 114 is a metal member disposed on an inner peripheral wall of the outer casing 111 and in close contact with the inner peripheral wall of the outer casing 111. An end of the inner casing 114 adjacent to the opening 113 is spaced apart from the opening 113, and the actuating piece 130 abuts against the end of the inner casing 114. That is, the actuating piece 130 is in constant contact with the end of the inner casing 114. It should be noted that metal has a high thermal conductivity, by making the inner casing 114 into a metal member, when heat is transferred to the inner casing 114 made of metal, the inner casing 114 may quickly transfer the heat to the actuating piece 130, and the actuating piece 130 may react quickly according to the actual situation, thereby improving the sensitivity of the protection device 100. In one embodiment of the present disclosure, the outer casing 111 may be a plastic part. Plastic is a common material, and the outer casing 111 is made into a plastic part, which not only reduces the cost, but also simplifies the processing.

The protection device 100 for the battery 200 according to an embodiment of the present disclosure will be described in detail below with reference to FIGS. 1-2 in a specific embodiment. It will be appreciated that the following description is only illustrative and not specifically restrictive to the present disclosure.

In FIG. 1, the actuating piece 130 of the protection device 100 is in a normal state. In FIG. 2, the actuating piece 130 is deformed and pierces the sealing film 120.

As shown in FIG. 1 and FIG. 2, the protection device 100 includes: a casing assembly 110, a sealing film 120, a pressing ring 140, and a temperature-sensitive actuating piece 130.

The casing assembly 110 includes an outer casing 111 and an inner casing 114. The outer casing 111 is a plastic part and defines a receiving chamber 112 for receiving an inert gas (e.g., nitrogen or helium). An upper end (upper end as shown in FIG. 1 and FIG. 2) of the receiving chamber 112 is open, that is, the upper end of the outer casing 111 has an opening 113. The inner casing 114 is a metal member disposed on an inner peripheral wall of the outer casing 111 and in close contact with the inner peripheral wall of the outer casing 111. An upper end of the inner casing 114 is adjacent to the opening 113 and is spaced apart from the opening 113, and the actuating piece 130 abuts against the upper end of the inner casing 114. That is, the actuating piece 130 is placed at the upper end of the inner casing 114 and is in constant contact with the inner casing 114. When heat is transferred to the inner casing 114, the heat can be quickly transferred to the actuating piece 130 through the inner casing 114 made of metal. Therefore, the reaction speed of the protection device 100 can be increased, so that it can respond quickly to an unexpected situation.

The sealing film 120 may be a plastic film and is disposed at the opening 113 to seal the receiving chamber 112. The receiving chamber 112 is filled with inert gas. When the inert gas is released, the presence of the inert gas may be sensed by a detection device for detecting the inert gas within a certain space, or the release of the inert gas may be sensed by detecting the pressure within a space where the protection device 100 is located. For example, when the protection device 100 and the battery 200 are assembled together into a mounting space of the battery 200, and when the inert gas in the protection device 100 is released, the pressure in the mounting space is increased, so that the state of the protection device 100 can be monitored by detecting the pressure in the mounting space.

The actuating piece 130 may be a memory alloy piece. The memory alloy piece is highly sensitive to temperature, thereby improving the sensitivity of the protection device 100. As shown in FIG. 1, the actuating piece 130 is provided with a piercing protrusion 131, and a free end of the piercing protrusion 131 is formed as a tip end 132. When the actuating piece 130 is deformed, the piercing protrusion 131 is driven to pierce the sealing film 120. Specifically, the temperature-sensitive actuating piece 130 may produce a certain amount of deformation when the temperature of the space where the protection device 100 is located changes. When the amount of deformation of the actuating piece 130 is sufficiently large, the actuating piece 130 drives the piercing protrusion 131 to pierce the sealing film 120 to release the inert gas.

As shown in FIG. 1 and FIG. 2, the pressing ring 140 is disposed on the actuating piece 130 and is in close contact with the actuating piece 130. The piercing protrusion 131 passes through the pressing ring 140 and protrudes toward the sealing film 120. The pressing ring 140 may fix the actuating piece 130 at the opening 113 of the casing assembly 110, so that the actuating piece 130 can be prevented from accidentally falling off or accidentally piercing the sealing film 120, thereby improving the reliability and sensitivity of the protection device 100.

Therefore, by utilizing the temperature-sensitive characteristic of the actuating piece 130, when the actuating piece 130 is deformed, the piercing protrusion 131 can be driven to pierce the sealing film 120, so as to release the inert gas in the receiving chamber 112. After the inert gas in the receiving chamber 112 is released, the state of the protection device 100 can be monitored by detecting the inert gas, so that the working state of the battery 200 can be monitored. Therefore, it is convenient to monitor the state of the battery 200, and the abnormal heat generation condition of the battery 200 can be found in time, thereby improving the working safety and stability of the battery 200.

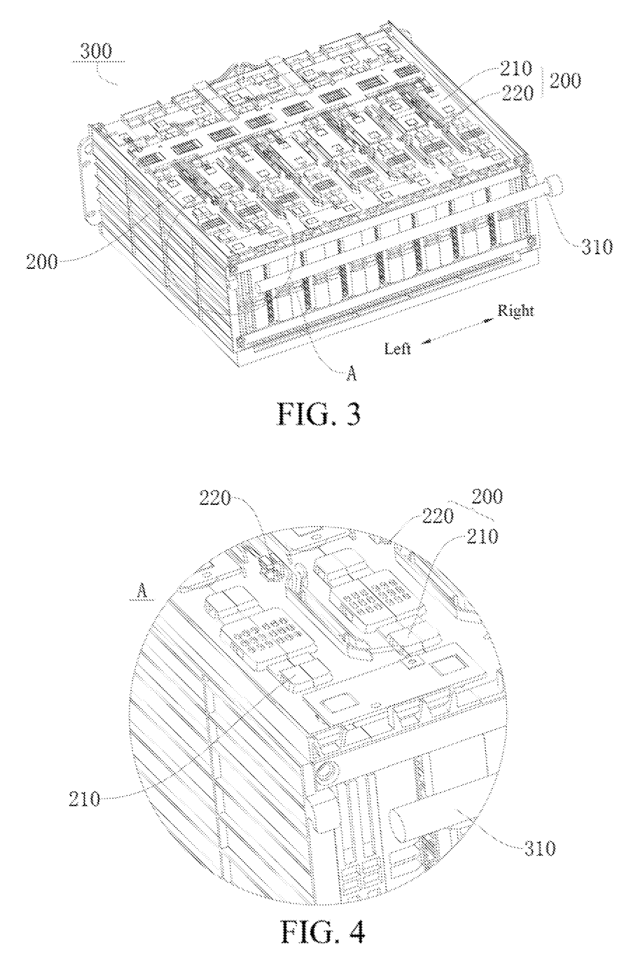

As shown in FIGS. 3-6, a battery 200 according to an embodiment of the present disclosure includes: a battery body 210, a spraying assembly 220, a fire-fighting sensing assembly, and the protection device 100 as described above.

Specifically, the spraying assembly 220 corresponds to the battery body 210 and is adapted to spray a fire extinguishing agent to the battery body 210. The fire-fighting sensing assembly is in communication connection with the spraying assembly 220. When an inert gas in the protection device 100 is released, the fire-fighting sensing assembly may sense the inert gas and transmit information to the spraying assembly 220, and the spraying assembly 220 sprays the fire-extinguishing agent to the battery body 210 to achieve the fire-fighting effect. It should be noted that the present disclosure does not limit a positional relationship and a connection relationship between the battery body 210 and the spraying assembly 220 as long as the spraying assembly 220 corresponds to the battery body 210 and can spray the fire extinguishing agent toward the battery body 210.

It will be appreciated that when the battery 200 is in a situation such as a short circuit or an open flame which is liable to cause a fire, the ambient temperature around the battery 200 will rise. When heat on the battery 200 is transferred to the protection device 100 and the actuating piece 130 senses a higher temperature, the actuating piece 130 will be deformed. When the temperature rises to a certain extent, the actuating piece 130 generates a large amount of deformation, so as to drive the piercing protrusion 131 to pierce the sealing film 120, thereby releasing the inert gas.

The fire-fighting sensing assembly may be a pneumatic sensing assembly or an assembly for sensing an inert gas. When the fire-fighting sensing assembly is an assembly for sensing an inert gas, the fire-fighting sensing assembly may sense the inert gas when an inert gas is released. When the fire-fighting sensing assembly is a pneumatic sensing assembly, if an inert gas is released, the ambient pressure around the battery 200 will change, and the fire-fighting sensing assembly may determine that the inert gas is released by sensing the change of the pressure, thereby determining that the battery 200 is in an abnormal working state.

When the fire-fighting sensing assembly senses that the inert gas is released, it may communicate with the spraying assembly 220 to transmit the information to the spraying assembly 220, and the spraying assembly 220 may spray the fire extinguishing agent to the battery 200.

In the battery 200 according to an embodiment of the present disclosure, by utilizing the temperature-sensitive characteristic of the actuating piece 130, when the actuating piece 130 is deformed, the piercing protrusion 131 can be driven to pierce the sealing film 120, so as to release the inert gas in the receiving chamber 112. After the inert gas in the receiving chamber 112 is released, the state of the protection device 100 can be monitored by detecting the inert gas, so that the working state of the battery 200 can be monitored. Therefore, it is convenient to monitor the state of the battery 200, and the abnormal heat generation condition of the battery 200 can be found in time, thereby improving the working safety and stability of the battery 200.

As shown in FIGS. 3-6, a battery pack 300 according to an embodiment of the present disclosure includes a plurality of batteries 200 as described above.

In the battery pack 300 according to an embodiment of the present disclosure, by utilizing the temperature-sensitive characteristic of the actuating piece 130, when the actuating piece 130 is deformed, the piercing protrusion 131 can be driven to pierce the sealing film 120, so as to release the inert gas in the receiving chamber 112. After the inert gas in the receiving chamber 112 is released, the state of the protection device 100 can be monitored by detecting the inert gas, so that the working state of the battery 200 can be monitored. Therefore, it is convenient to monitor the state of the battery 200, and the abnormal heat generation condition of the battery 200 can be found in time, thereby improving the working safety and stability of the battery pack 300.

In one embodiment of the present disclosure, as shown in FIGS. 3-6, in order to improve the integrity of the battery pack 300, the battery pack 300 includes a box. The box is composed of a plurality of cover plates 330. A plurality of batteries 200 are arranged in a left-right direction in the box to be configured as the battery pack 300. A fire-fighting pipeline 310 may be disposed along the periphery of the battery pack 300, and the fire-fighting pipeline 310 may have a plurality of pipeline branches. Each battery 200 corresponds to at least one pipeline branch, and a free end of the pipeline branch may be provided with the spraying assembly 220. That is, each battery 200 corresponds to the spraying assembly 220, and the spraying assembly 220 may extinguish the corresponding battery 200.

When one or more of the batteries 200 in the battery pack 300 are short-circuited or the like, which may cause a fire, the spraying assembly 220 corresponding to the battery 200 sprays the fire extinguishing agent to the battery 200, thereby further extinguishing the battery 200 in a point-to-point extinguishing manner. Therefore, the fire extinguishing accuracy of the battery pack 300 can be improved. In addition, a fan 320 may be disposed on the cover plate 330 for ventilating the battery pack 300 inside the cover plate 330, thereby reducing the temperature around the battery 200 and improving the performance of the battery 200.

In a specific embodiment of the present disclosure, the protection device 100 is disposed within a pipeline branch of the fire-fighting pipeline 310 and is in communication with the pipeline branch. When the fire-fighting pipeline 310 is arranged completely, the entire pipeline is filled with an inert gas, that is, the protection device 100 is filled with an inert gas.

The outer casing 111 of the protection device 100 may be integrally formed with the pipeline branch, and the inner casing 114 of the protection device 100 may be configured as a metal pipe disposed within the pipeline branch.

When the temperature of the battery rises, the metal pipe disposed inside the pipeline branch (i.e., the inner casing 114 of the protection device 100) transfers heat to the actuating piece 113. When the heat transferred to the actuating piece 113 reaches a certain extent, the actuating piece 113 undergoes a large deformation to drive the piercing protrusion 131 to pierce the sealing film 120, thereby releasing the inert gas in the protection device 100. Therefore, the fire-fighting sensing assembly senses the leakage of the inert gas, the fire-extinguishing agent is transmitted to the corresponding spraying assembly 220 through the fire-fighting pipeline 310, and the spraying assembly 220 sprays the fire-extinguishing agent to the battery 200, thereby cooling or extinguishing the battery 200 to avoid the battery from being exploded.

It should be noted that the position of the protection device 100 according to an embodiment of the present disclosure is not limited to the above specific embodiment. For example, the protection device 100 may be disposed at other positions of the battery pack 300 as long as the above-described structure and function of the protection device 100 can be achieved without colliding with other components of the battery pack 300.

The vehicle according to an embodiment of the present disclosure includes the battery pack 300 as described above.

In the vehicle according to an embodiment of the present disclosure, by utilizing the temperature-sensitive characteristic of the actuating piece 130, when the actuating piece 130 is deformed, the piercing protrusion 131 can be driven to pierce the sealing film 120, so as to release the inert gas in the receiving chamber 112. After the inert gas in the receiving chamber 112 is released, the state of the protection device 100 can be monitored by detecting the inert gas, so that the working state of the battery 200 can be monitored. Therefore, it is convenient to monitor the state of the battery 200, and the abnormal heat generation condition of the battery 200 can be found in time, thereby improving the safety and stability of the battery pack 300 and the vehicle.

In the descriptions of this specification, descriptions such as reference terms “an embodiment”, “some embodiments”, “example”, “specific example”, or “some examples” intend to indicate that specific features, structures, materials, or characteristics described with reference to embodiments or examples are included in at least one embodiment or example of this disclosure. In this specification, exemplary descriptions of the foregoing terms do not necessarily refer to a same embodiment or example. In addition, the described specific features, structures, materials, or characteristics may be combined in a proper manner in any one or more of the embodiments or examples. In addition, a person skilled in the art may integrate or combine different embodiments or examples and characteristics of different embodiments or examples described in the specification, as long as they do not conflict each other.

Although the embodiments of the present disclosure are shown and described above, it can be understood that the foregoing embodiments are exemplary, and should not be construed as limitations to the present disclosure. A person of ordinary skill in the art can make changes, modifications, replacements, and variations to the foregoing embodiments within the scope of the present disclosure.

What is claimed is:

1. A protection device for a battery, comprising:
a casing assembly, wherein a receiving chamber for receiving inert gas is defined in the casing assembly, one end of the receiving chamber is provided with an opening;
a sealing film, disposed at the opening to seal the receiving chamber; and
a temperature-sensitive and deformable actuating piece, disposed in the receiving chamber and provided with a piercing protrusion, wherein
when the actuating piece is deformed in response to a temperature change of the battery, the piercing protrusion is driven to pierce the sealing film.

2. The protection device for a battery according to claim 1, further comprising a pressing ring, wherein the pressing ring is disposed on the actuating piece and is in close contact with the actuating piece, and the piercing protrusion passes through the pressing ring and protrudes toward the sealing film.

3. The protection device for a battery according to claim 1, wherein a free end of the piercing protrusion is formed as a tip end.

4. The protection device for a battery according to claim 1, wherein the sealing film is a plastic film.

5. The protection device for a battery according to claim 1, wherein the actuating piece is a memory alloy piece.

6. The protection device for a battery according to claim 1, wherein the casing assembly comprises:
an outer casing, defining the receiving chamber, the opening of the receiving chamber being located at one end of the outer casing; and
an inner casing, which is a metal member disposed on an inner peripheral wall of the outer casing and is in close contact with the inner peripheral wall of the outer casing, wherein an end of the inner casing adjacent to the opening is spaced apart from the opening, the actuating piece abuts against the end of the inner casing.

7. The protection device for a battery according to claim 6, wherein the outer casing is a plastic part.

8. A battery, comprising:
a battery body;
a spraying assembly, corresponding to the battery body and configured to spray a fire extinguishing agent to the battery body;
the protection device for a battery according to claim 1; and
a fire-fighting sensing assembly, adapted configured to sense that an inert gas in the protection device is released, wherein the fire-fighting sensing assembly is in communication connection with the spraying assembly, wherein
when the inert gas in the protection device is released, the spraying assembly sprays the fire extinguishing agent to the battery body.

9. A battery pack, comprising:
a box;
a plurality of batteries according to claim 8, disposed in the box; and
a fire-fighting pipeline, disposed along the periphery of the battery pack, wherein the fire-fighting pipeline has a plurality of pipeline branches, each battery corresponds to at least one pipeline branch, a free end of each pipeline branch is connected to a spraying assembly of the battery.

10. A vehicle, comprising the battery pack according to claim 9.

11. The protection device for a battery according to claim 2, wherein a free end of the piercing protrusion is formed as a tip end.

12. The protection device for a battery according to claim 11, wherein the sealing film is a plastic film.

13. The protection device for a battery according to claim 12, wherein the actuating piece is a memory alloy piece.

14. The protection device for a battery according to claim 13, wherein the casing assembly comprises:
an outer casing, defining the receiving chamber, the opening of the receiving chamber being located at one end of the outer casing; and
an inner casing, which is a metal member disposed on an inner peripheral wall of the outer casing and is in close contact with the inner peripheral wall of the outer casing, wherein an end of the inner casing adjacent to the opening is spaced apart from the opening, the actuating piece abuts against the end of the inner casing.

15. The protection device for a battery according to claim 14, wherein the outer casing is a plastic part.

16. A battery, comprising:
a battery body;
a spraying assembly, corresponding to the battery body and configured to spray a fire extinguishing agent to the battery body;
the protection device for a battery according to claim 15; and
a fire-fighting sensing assembly, configured to sense that an inert gas in the protection device is released, wherein the fire-fighting sensing assembly is in communication connection with the spraying assembly, wherein
when the inert gas in the protection device is released, the spraying assembly sprays the fire extinguishing agent to the battery body.

17. A battery pack, comprising:
a box;
a plurality of batteries according to claim 16, the plurality of batteries being disposed in the box; and
a fire-fighting pipeline, disposed along the periphery of the battery pack, wherein the fire-fighting pipeline has a plurality of pipeline branches, each battery corresponds to at least one pipeline branch, a free end of each pipeline branch is connected to a spraying assembly of the battery.

18. A vehicle, comprising the battery pack according to claim 17.
